(19) United States
(12) Patent Application Publication
(10) Pub. No.: US 2012/0075600 A1
(43) Pub. Date: Mar. 29, 2012

(54) IMAGING APPARATUS, IMAGING SYSTEM, AND METHOD FOR CONTROLLING IMAGING APPARATUS

(75) Inventors: Sho Sato, Kumagaya-shi (JP); Tadao Endo, Honjo-shi (JP); Toshio Kameshima, Kumagaya-shi (JP); Tomoyuki Yagi, Honjo-shi (JP); Katsuro Takenaka, Honjo-shi (JP); Keigo Yokoyama, Honjo-shi (JP); Atsushi Iwashita, Honjo-shi (JP)

(73) Assignee: CANON KABUSHIKI KAISHA, Tokyo (JP)

(21) Appl. No.: 13/231,062

(22) Filed: Sep. 13, 2011

(30) Foreign Application Priority Data
Sep. 28, 2010 (JP) 2010-216924

(51) Int. Cl. G03B 27/02

(52) U.S. Cl. 355/18

(57) ABSTRACT

An imaging apparatus includes a detector in which a plurality of pixels are arranged in a matrix; each pixel includes a conversion element that converts radiation or light into an electric charge. The detector performs an exposure imaging operation for outputting exposure image data, a correction imaging operation for outputting correction image data, and a correction imaging preparation operation including an initialization operation for initializing the conversion element between the exposure imaging operation and the correction imaging operation. A correction unit corrects the exposure image data using the correction image data; and a control unit controls the operation of the detector so that the detector performs the initialization operation based on an amount of variation in offset of the conversion element at the time of transitioning from an exposure imaging preparation operation to the exposure imaging operation.

### BACKGROUND OF THE INVENTION

1. Field of the Invention

The present invention relates to an imaging apparatus, an imaging system, and a method for controlling the imaging apparatus. More specifically, the present invention relates to an imaging apparatus used for a radiation imaging apparatus and a radiation imaging system which are preferably used for still imaging such as general imaging in medical diagnosis and moving imaging such as X-ray radioscopic imaging and a method for controlling the imaging apparatus.

2. Description of the Related Art

In recent years, a radiation imaging apparatus using a flat panel detector (FPD) formed of a semiconductor material has been put into practical use as an imaging apparatus used for an X-ray medical image diagnosis and an X-ray nondestructive inspection. Such a radiation imaging apparatus has been used as a digital imaging apparatus for the still imaging such as general imaging and for moving imaging such as X-ray radioscopic imaging in medical image diagnosis, for example.

U.S. Pat. No. 6,115,451 discusses a radiation imaging apparatus which subjects the image acquired by radiation imaging to an offset removal process. The offset largely results from the dark current of a detector. It is desirable to perform an offset correction for removing the offset from the reading of the detector to improve image quality.

U.S. Pat. No. 6,115,451 discusses an imaging method for acquiring more appropriate offset reading values to reduce an image artifact. According to U.S. Pat. No. 6,115,451, before exposure reading is performed, reading without storing data is repeated during the standby-operation time period (hereinafter, referred to as an exposure preparation period) before exposure reading.

The reading operation is repeated N times (N is integer equal to or larger than one) after the exposure reading, and then the offset reading is performed. The larger the N is, the larger an artifact removal effect is. This method allows the offset reading to be performed after the detector is artificially restored to a state before exposure.

The offset (dark current) causes a problem due to the following reason in the detector using a photoelectric conversion element. As discussed in U.S. Pat. No. 6,448,561, a large dark current flows immediately after the power supply of the radiation imaging apparatus is turned on to apply a bias to the photoelectric conversion element, and it takes much time until the offset stabilizes. Thus, the offset varies until the offset stabilizes after the bias is applied to the photoelectric conversion element. Therefore, it is desirable to perform offset correction to correct the variation in the offset.

The offset correction discussed in U.S. Pat. No. 6,115,451 cannot satisfactorily deal with the variation in the offset discussed in U.S. Pat. No. 6,448,561, and the image artifact may be increased.

On the other hand, the method discussed in U.S. Pat. No. 6,448,561 cannot perform imaging until the offset stabilizes after the bias is applied to the photoelectric conversion element, so that the method cannot meet a demand for reducing the exposure preparation period.

### SUMMARY OF THE INVENTION

The present invention is directed to an imaging apparatus and an imaging system capable of reducing the exposure preparation period and performing a suitable offset correction for the variation in the offset.

According to an aspect of the present invention, an imaging apparatus includes a detector in which a plurality of pixels each including a conversion element configured to convert radiation or light into an electric charge is arranged in a matrix, wherein the detector performs an exposure imaging operation for outputting exposure image data corresponding to radiation or light with which the detector is irradiated, a correction imaging operation for outputting correction image data that is image data in a dark state for correcting the exposure image data, an exposure preparation operation for stabilize the characteristic of the conversion element during the time between the start of application of a bias to the conversion element and the exposure imaging operation, and a correction imaging preparation operation including an initialization operation for initializing the conversion element between the exposure imaging operation and the correction imaging operation, a correction unit configured to correct the exposure image data using the correction image data, and a control unit configured to control the operation of the detector, wherein the control unit determines the number of times of the initialization operation according to the amount of variation in offset at the time of shifting from the exposure preparation operation to the exposure imaging operation, and controls the operation of the detector so as to perform the initialization operation based on the determined number of times.

According to the present invention, there are provided an imaging apparatus and an imaging system which can not only meet the demand for reducing the exposure preparation period, but also perform a suitable offset correction for the variation in the offset. The offset correction is performed according to the length of the exposure preparation period to always allow acquiring a radiation image with fewer artifacts.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic diagram of an imaging system including an imaging apparatus according to an exemplary embodiment of the present invention.

FIG. 2 is a schematic equivalent circuit of the imaging apparatus according to an exemplary embodiment of the present invention.

FIG. 3 is a flow chart illustrating an operation of the imaging apparatus and the imaging system according to a first exemplary embodiment of the present invention.

FIG. 4A illustrates a characteristic of the amount of variation in offset versus time in the imaging apparatus according to an exemplary embodiment of the present invention.

FIG. 4B illustrates information for determining operations according to an exemplary embodiment of the present invention.

FIGS. 5A and 5B are timing charts illustrating the operation of the imaging apparatus and the imaging system according to the first exemplary embodiment of the present invention.

FIGS. 6A, 6B, and 6C are timing charts illustrating the operation of the imaging apparatus and the imaging system according to the first exemplary embodiment of the present invention.

FIG. 7 is a flow chart illustrating an operation of the imaging apparatus and the imaging system according to a second exemplary embodiment of the present invention.

FIGS. 8A, 8B, and 8C are timing charts illustrating the operation of the imaging apparatus and the imaging system according to the second exemplary embodiment of the present invention.

FIGS. 9A, 9B, and 9C are timing charts illustrating the operation of the imaging apparatus and the imaging system according to the second exemplary embodiment of the present invention.

FIGS. 10A, 10B, and 10C are timing charts illustrating the operation of the imaging apparatus and the imaging system according to the second exemplary embodiment of the present invention.

FIG. 11 is a schematic equivalent circuit of the imaging apparatus according to the second exemplary embodiment of the present invention.

FIGS. 12A and 12B are timing charts illustrating the operation of the imaging apparatus and the imaging system according to the second exemplary embodiment of the present invention.

### DESCRIPTION OF THE EMBODIMENTS

Various exemplary embodiments, features, and aspects of the invention will be described in detail below with reference to the drawings.

A radiation in the present invention includes not only α ray, β ray, γ ray which are beams made of particles (including photons) emitted by radioactive decay, but also beams whose energy is comparable thereto, for example, X ray, particle beam, and cosmic radiation.

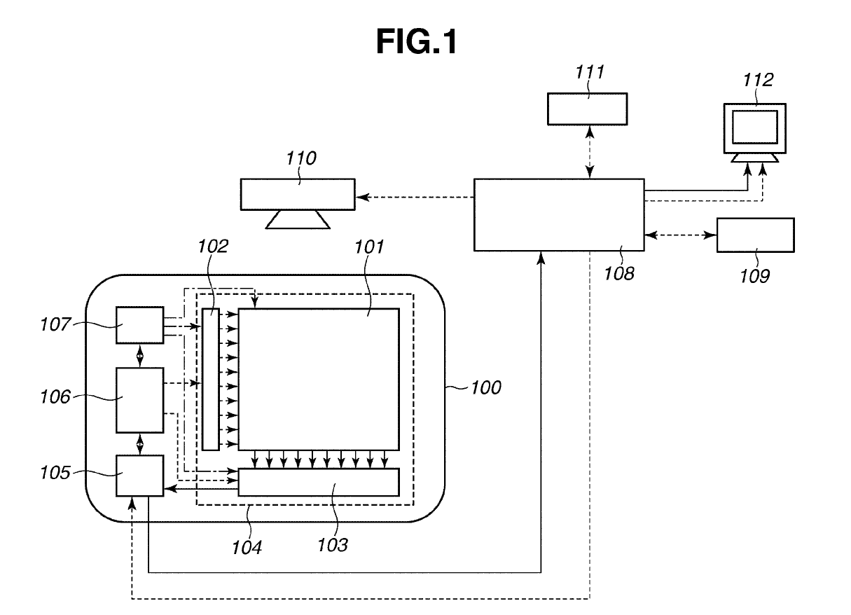

The imaging system of the present exemplary embodiment illustrated in FIG. 1 includes an imaging apparatus 100, a control computer 108, a imaging condition memory 109, a radiation generating apparatus 110, a console 111, and a display apparatus 112.

The imaging apparatus 100 includes a flat panel detector (FPD) 104 including a detection unit 101 provided with a plurality of pixels which convert radiation or light into an electric signal, a drive circuit 102 which drives the detection unit 101, and a read circuit 103 which outputs the electric signal output from the driven detection unit 101 as image data. The imaging apparatus 100 further includes a signal processing unit 105, such as a microprocessor or the like, which processes and outputs the image data from the FPD 104, a control unit 106 which supplies to each component a control signal to control the operation of the FPD 104, and a power supply unit 107, such as a direct current (DC) battery or an alternate current (AC) voltage connection, which supplies a bias (e.g., bias voltage) to each component.

The signal processing unit 105 receives a control signal from the control computer 108 to be described later and provides the control signal to the control unit 106. The power supply unit 107 includes a power supply circuit such as a regulator which receives a voltage from an external power supply or a built-in battery (not illustrated) and supplies the required voltage to the detection unit 101, the drive circuit 102, and the read circuit 103.

The control computer 108 transmits the control signal for synchronizing the radiation generating apparatus 110 with the imaging apparatus 100, and for determining the state of the imaging apparatus 100, and performs image processing for correction, storage, and display on the image data acquired from the imaging apparatus 100. The control computer 108 records the timing at which the application of a bias to a conversion element is started and the timing at which the imaging apparatus 100 receiving an exposure request signal starts an exposure imaging operation to be described below, and calculates the length of the exposure preparation period.

The control computer 108 records an operation mode of the imaging apparatus 100 when the exposure request signal is transmitted from the console 111. The control computer 108 stores the measured length of the exposure preparation period and the recorded operation mode in the imaging condition memory 109.

The imaging condition memory 109 may include a hard disk drive (HDD) built in the control computer 108, or it may include a removable memory device, such as a portable read-only-memory (ROM) storing thereon predetermined information. The information stored in the imaging condition memory 109 may include, determination information about the length of the exposure preparation period, an offset variation characteristic, and a threshold value (or range of values), and an operation table as operation determination information. The determination information is stored in the imaging condition memory 109 for each operation mode. The determination information and the operation determination information are described in detail below.

The control computer 108 determines whether the offset is greater than the threshold based on the length of the exposure preparation period, the operation mode, and the determination information according to the operation mode. The control computer 108 stores determination results in the imaging condition memory 109. The control computer 108 determines the operation of the imaging apparatus 100 based on the operation mode, the determination results, and the operation determination information, and transmits a control signal according to the determined operation to the control unit 106.

The control computer 108 transmits the control signal for determining irradiation conditions for radiation and the exposure request signal to the radiation generating apparatus 110 based on information from the console 111. The exposure preparation console 111 inputs subject information and imaging conditions as parameters for various controls of the control computer 108, and transmits an imaging condition and the exposure request signal to the control computer 108.

The display apparatus 112 displays image data on which the image processing is performed by the control computer 108. The control unit of the present invention includes the control unit 106, the control computer 108, and the imaging condition memory 109 in the present exemplary embodiment. In the present invention, the control computer 108 and the imaging condition memory 109 may be included in the imaging apparatus 100.

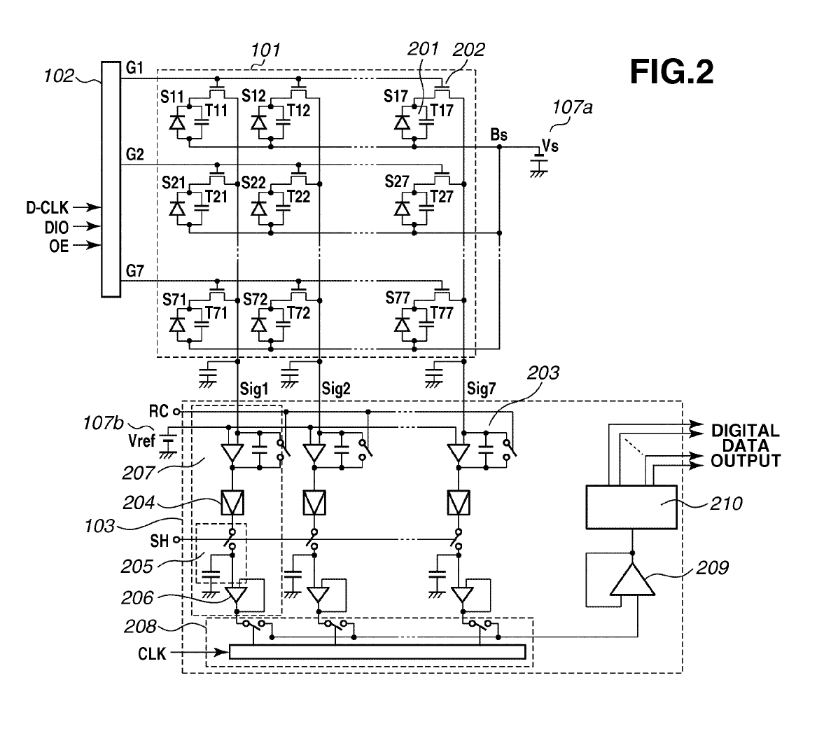

An imaging apparatus according to the first exemplary embodiment of the present invention is described below with reference to FIG. 2. The components similar in configuration to those illustrated in FIG. 1 are given the same reference numbers and the description thereof is omitted herein. For the sake of simplicity, FIG. 2 illustrates the imaging apparatus including an FPD having pixels of seven rows by seven columns. However, an actual imaging apparatus has a larger number of pixels and has pixels of about 2800 rows by about 2800 columns, for example, in a 17-inch imaging apparatus.

The detection unit 101 (detector) has a plurality of pixels arranged in a matrix form (matrix). The pixel includes a conversion element 201 which converts radiation or light into an electric charge and a switch element 202 which outputs an electric signal according to the electric charge.

In the present exemplary embodiment, a PIN photo diode which is arranged on an insulative substrate such as glass substrate and made of amorphous silicon is used as a photoelectric conversion element which converts light irradiated in the conversion element into an electric charge. As the conversion element, an indirect conversion element equipped with a wavelength converter which converts radiation into light whose wavelength band can be detected by the photoelectric conversion element at a place where the radiation is incident on the above photoelectric conversion element or a direct conversion element which directly converts radiation into an electric charge are used.

As the switch element 202, a transistor including a control terminal and two main terminals is desirably used. In the present exemplary embodiment, a thin film transistor (TFT) is used as the switch element 202. One electrode of the conversion element 201 is electrically connected to one of two main terminals and the other electrode thereof is electrically connected to a bias power supply 107a via a common bias wiring Bs.

The control terminals of a plurality of switch elements in the row direction, T11 to T17, for example, are electrically and commonly connected to a drive wiring G1 in a first row. A drive circuit 102 provides a drive signal for controlling the conduction state of the switch element via the drive wiring G1 on a row basis.

The other main terminals of a plurality of switch elements in the column direction, T11 to T71, for example, are electrically connected to a signal wiring Sig 1 in a first column. The electric signal according to the electric charge of the conversion element 201 is output to the read circuit 103 via the signal wiring Sig 1 while the switch element 202 is in a conduction state. A plurality of the signal wirings Sig 1 to Sig 7 arranged in the column direction transfers electric signals output from a plurality of pixels in parallel to the read circuit 103.

The read circuit 103 includes an amplification circuit 207 for amplifying the electric signal output in parallel from the detection unit 101, provided for each signal wiring. Each amplification circuit 207 includes an integrating amplifier 203 for amplifying the output electric signal, a variable amplifier 204 for amplifying the electric signal from the integrating amplifier 203, a sample and hold circuit 205 for sampling and holding the amplified electric signal, and a buffer amplifier 206.

The integrating amplifier 203 includes an operational amplifier for amplifying the read electric signal and outputting the amplified signal, an integral capacity, and a reset switch. The integrating amplifier 203 is capable of changing an amplification factor by changing the value of the integral capacity.

The output electric signal is input to the inverting input terminal of the operational amplifier, a reference voltage Vref is input to the non-inverting input terminal thereof from a reference power supply 107b, and the amplified electric signal is output from the output terminal thereof. The integral capacity is arranged between the inverting input terminal and output terminal.

The sample and hold circuit 205 is provided for each of the amplification circuits 207 and includes a sampling switch and a sampling capacitor. The read circuit 103 includes a multiplexer 208 which sequentially outputs the electric signals read in parallel from each of the amplification circuits 207 as image signals of series signals and a buffer amplifier 209 for outputting the impedance-converted image signal.

An image signal Vout being an analog electric signal output from the buffer amplifier 209 is converted into digital image data by an A/D converter 210, and the image data processed by the signal processing unit 105 is output to the control computer 108.

The drive circuit 102 outputs a drive signal including a conduction voltage Vcom which brings the switch element into a conduction state and a non-conduction voltage Vss which brings the switch element into a non-conduction state to each drive wiring, according to the control signal input from the control unit 106 (D-CLK, OE, DIO). Thereby, the drive circuit 102 controls the conduction and non-conduction states of the switch element to drive the detection unit 101.

The power supply unit 107 illustrated in FIG. 1 includes the bias power supply 107a and the reference power supply 107b of the amplification circuit illustrated in FIG. 2. The bias power supply 107a commonly supplies a bias voltage Vs to the other electrode of each conversion element via the bias wiring Bs. The reference power supply 107b supplies the reference voltage Vref to the non-inverting input terminal of the operational amplifier.

The control unit 106 illustrated in FIG. 1 receives a control signal from the control computer 108 outside the imaging apparatus via the signal processing unit 105, and provides the drive circuit 102, the power supply unit 107, and the read circuit 103 with various control signals to control the FPD 104. The control unit 106 illustrated in FIG. 1 provides the drive circuit 102 illustrated in FIG. 2 with control signals D-CLK, OE, and DIO to control the operation of the drive circuit 102.

The control signal D-CLK is a shift clock of a shift register used as the drive circuit, the control signal DIO is a pulse transferred by the shift register, and the control signal OE controls the output terminal of the shift register.

The control unit 106 provides the read circuit 103 illustrated in FIG. 2 with control signals RC, SH, and CLK to control the operation of each component of the read circuit 103. The control signal RC controls the operation of the reset switch of the integrating amplifier 203, the control signal SH controls the operation of the sample and hold circuit 205, and the control signal CLK controls the operation of the multiplexer 208.

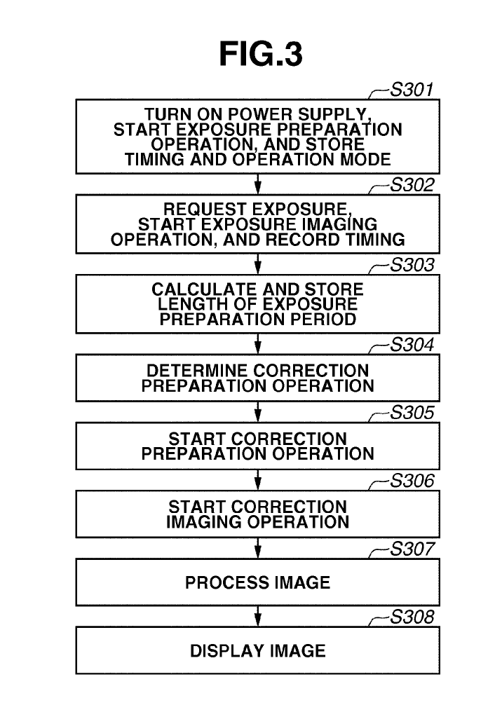

The operation of the imaging apparatus and the imaging system of the present invention is described below with reference to FIGS. 1 and 3.

In step S301, the control computer 108 determines the operation mode and the irradiation conditions of radiation by the operator operating the console 111. In step S302, the operator operates the console 111 to instruct starting imaging to cause the control computer 108 to provide the control unit 106 with a control signal for turning on the power supply of the FPD 104, and store the timing at which the application of a bias to the conversion element is started and the operation mode.

The power supply of the FPD 104 is turned on to apply the bias to the conversion element. The application of the bias to the conversion element causes the imaging apparatus to enter the exposure preparation period during which the imaging apparatus performs the exposure preparation operation. The operator by operating the console 111 transfers the exposure request signal to the control computer 108. The control computer 108 applies the control signal based on the exposure request signal to the control unit 106 of the imaging apparatus 100.

The control unit 106 receiving the control signal controls the operation of the imaging apparatus 100 so that the imaging apparatus 100 shifts from the exposure preparation operation to the exposure imaging operation. When the imaging apparatus 100 starts the exposure imaging operation, the control unit 106 informs the control computer 108 that the exposure operation is started. The control computer 108 receiving thereof records the timing at which the exposure imaging operation is started.

In step 303, the control computer 108 calculates the length of the exposure imaging preparation period based on the timing at which the application of the bias to the conversion element is started and the timing at which the exposure imaging operation is started, and records the length in the imaging condition memory 109.

In step 304, the control computer 108 determines whether the amount of variation in offset is greater than a threshold based on the length of the exposure imaging preparation period, the operation mode, and the determination information according to the operation mode. The control computer 108 stores determination results in the imaging condition memory 109.

The control computer 108 determines the operation of the imaging apparatus 100 during the exposure imaging preparation period based on the operation mode, the determination results, and the operation determination information. The radiation generating apparatus 110 irradiates an object with radiation at a desired timing according to the exposure request signal from the control computer 108.

The imaging apparatus 100 captures an exposure image according to the radiation passing through the object during the exposure imaging period. In step 306, the imaging apparatus 100 performs the exposure imaging preparation operation determined by the control computer 108 in step S305. Thereafter, the imaging apparatus 100 performs a correction imaging operation in which a correction image as an image in a dark state for correcting the exposure image is captured.

The control computer 108 including a correction unit subjects the exposure image data acquired by capturing the exposure image to the image processing which performs an offset correction using the correction image data acquired by capturing the correction image in step 307, and displays the image data on the display apparatus 113 in step 308.

In the above description, the correction unit is included in the control computer 108, however, the correction unit of the present invention is not limited to the above, but may be included in the signal processing unit 105. The exposure imaging preparation operation, the exposure imaging operation, the correction imaging preparation operation, and the correction imaging operation are described in detail below.

A preferable correction imaging preparation operation for acquiring the correction image data used for the offset correction is described. The influence of an image lag caused by the irradiation with radiation after the exposure imaging operation varies the amount of offset after that due to irradiation with radiation. The image lag results from traps existing in the aforementioned semiconductor.

The irradiation of the imaging apparatus 100 with radiation causes the conversion element 201 to generate electric charges according to the radiation with which the imaging apparatus 100 is irradiated, thereby activating the movement of carriers. For this reason, the movement of electrons and holes is activated due to the traps in the conversion element 201 after the exposure imaging operation, and the dark current of the detection unit 101 is increased.

Therefore, it is desirable to perform the exposure imaging preparation operation including initialization operation for reducing the dark current after the exposure imaging operation before the correction imaging operation.

It is more preferable to perform the initialization operation carried out before the correction imaging operation several times after the exposure imaging operation in order to further reduce the dark current and further stabilize variation in the offset. In such a case, the correction imaging operation is performed after a longer time elapses after the exposure imaging operation than in a case where the initialization operation is carried out once.

On the other hand, the power is supplied to the FPD 104 to start supplying the bias voltage Vs to the conversion element 201, causing variation in offset of the conversion element resulting from variation in dark current since the application of the bias voltage Vs in the FPD 104.

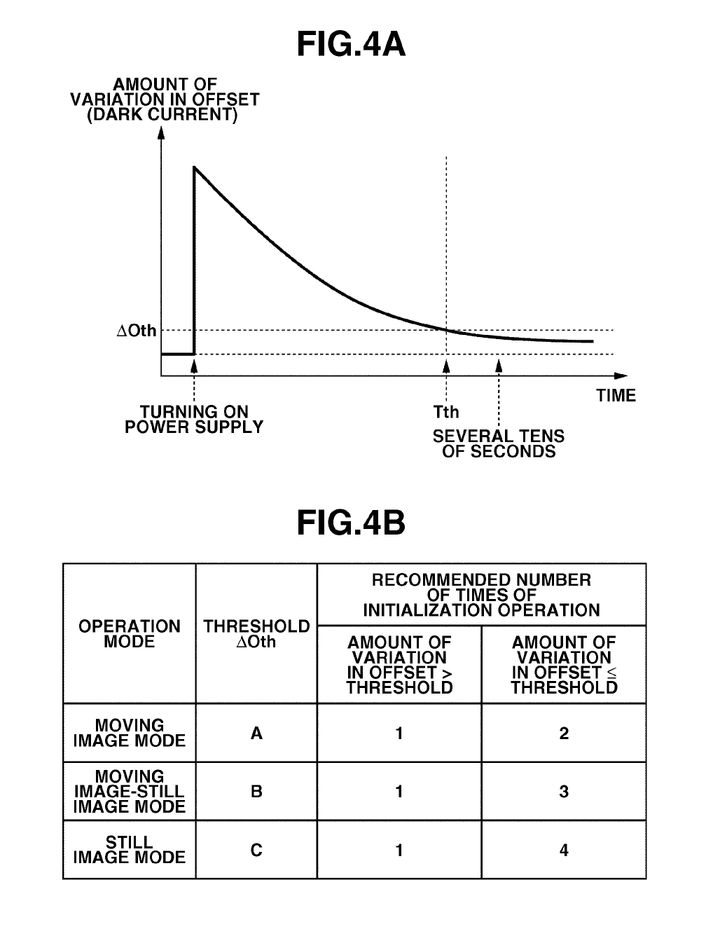

A characteristic in which the offset varies is referred to as “offset variation characteristic” and is described below with reference to FIG. 4A. In FIG. 4A, the abscissa indicates time since the power is supplied to the FPD 104 to supply the bias voltage Vs to the conversion element 201 until the targeted imaging operation is started in a dark state. The ordinate indicates the amount of variation in the offset (hereinafter referred to as “the amount of variation in the offset.”

The amount of variation in the offset denotes a difference between the offset in the FPD 104 included in the image data acquired by the preceding imaging operation and the offset in the FPD 104 included in the image data acquired by the succeeding targeted imaging operation.

As illustrated in FIG. 4A, the amount of variation in the offset has such a characteristic that the amount is maximized immediately after the power supply is turned on and thereafter the amount is stabilized with the elapse of time (hereinafter, referred to as “offset variation characteristic.” The offset variation characteristic is described below.

The offset in the FPD 104 results from the dark current in starting the application of the bias voltage Vs to the conversion element 201. Amorphous semiconductor such as amorphous silicon used for the conversion element 201 has a large number of traps due to dangling bonds.

At the moment of the application of the bias voltage Vs, a change in an electric field in the semiconductor activates the movement of electrons and holes due to the traps. This increases the dark current immediately after the application of the bias voltage Vs. The amount of the dark current exponentially decreases with time and becomes nearly the same as the case where carriers are moved due to heat after several tens of seconds, so that the dark current or the offset is stabilized to a substantially constant value.

Since the amount of variation in the offset has such a variation characteristic, if the exposure imaging preparation operation period is shorter than the predetermined time Tth and the offset is greater than a predetermined threshold Oth, the amount of variation in the offset becomes greater than a predetermined threshold ΔOth. In a case where the exposure imaging operation is performed in such a condition, if the correction imaging operation is performed after a long time elapses since the exposure imaging operation, the amount of variation in the offset increases to cause deterioration in correction accuracy of the offset correction.

If the exposure imaging preparation operation period is equal to or longer than the predetermined time Tth, the offset becomes equal to or smaller than the predetermined threshold Oth. In a case where the exposure imaging operation is performed in such a condition, even if the correction imaging operation is performed after a long time elapses since the exposure imaging operation, the amount of variation in the offset becomes equal to or smaller than the predetermined threshold ΔOth.

If the amount of variation in the offset becomes equal to or smaller than the predetermined threshold, the influence of variation in the offset in the acquired image data is lower than the level which can be recognized by an observer, which does not adversely affect the offset correction.

The present invention proposes the operation control of the imaging apparatus based on the time from the exposure imaging preparation operation after the application of power to the FPD 104 to the exposure imaging operation, i.e., the length of the exposure imaging preparation period. The present invention is characterized by switching the operation control of the imaging apparatus based on the offset variation characteristic, i.e., the amount of variation in the offset in transition from the exposure imaging preparation operation to the exposure imaging operation.

In the present exemplary embodiment, the control computer 108 determines whether the amount of variation in the offset is greater than the threshold based on the length of the exposure imaging preparation period and information about the offset variation characteristic stored in the imaging condition memory 109 as information for determination for each operation mode.

It is desirable to use plotted data by previously acquiring the amount of variation in the offset during the time period from the application of the bias voltage Vs to the start of the imaging operation in the dark state, as illustrated in FIG. 4A. Alternatively, only the threshold is previously acquired and the amount of variation in the offset may be timely acquired from the difference between the two offset image data continuously acquired in the exposure imaging preparation period.

The control computer 108 stores determination results in the imaging condition memory 109, and determines the operation of the imaging apparatus 100 in the correction imaging preparation period based on the operation mode, the determination results, and operation determination information. It is preferable to use a look-up table illustrated in FIG. 4B as the operation determination information.

The look-up table previously defines the recommended number of times of the initialization operation in the correction imaging preparation period based on results of comparison of the amount of variation in the offset with the threshold for each operation mode such as a moving image mode, a moving still image mode, and a still image mode. The recommended number of times is previously defined in consideration of frame rates (image data acquisition period) obtained in the operation modes. For example, it is desirable to define a smaller recommended number of times of the initialization operation in the moving image mode in which a high frame rate is required than in the still image mode in which a high frame rate is not required.

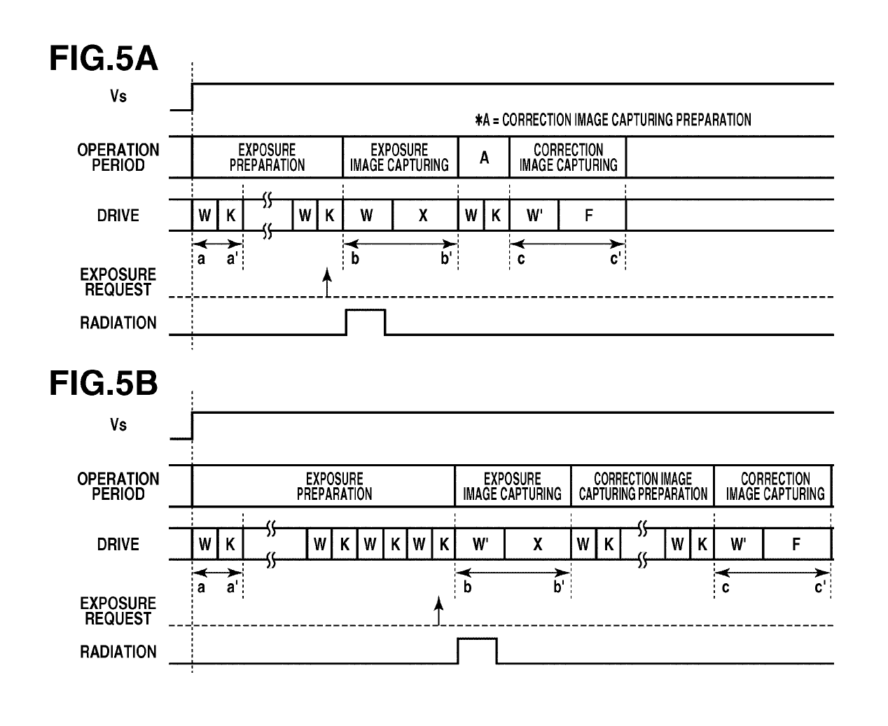

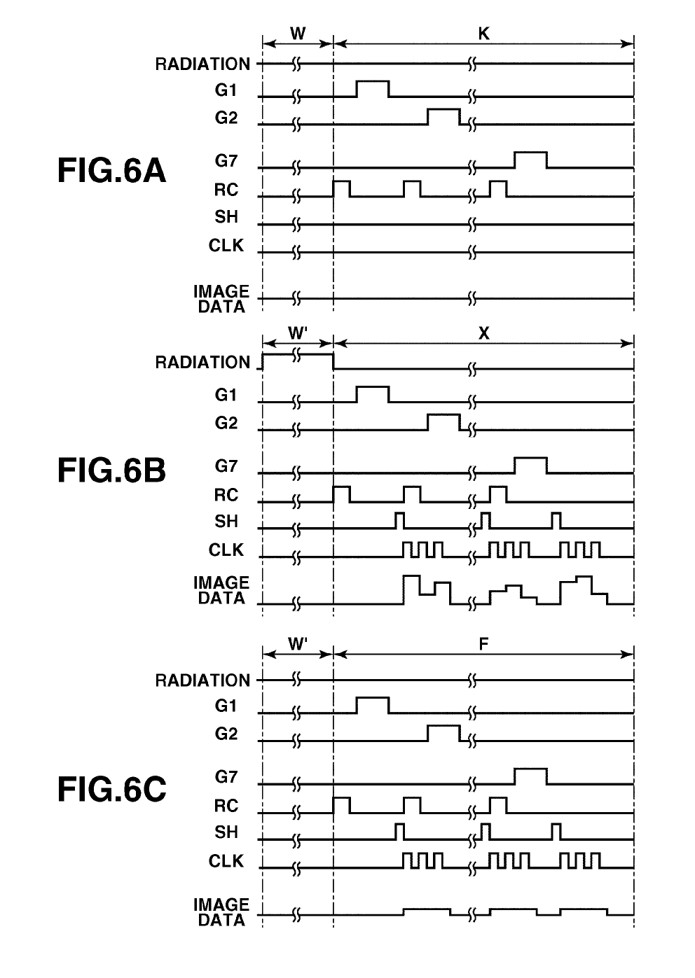

The operation of the imaging apparatus 100 is described below using the still image mode as an example referring to FIGS. 5A and 5B and FIGS. 6A to 6C. The timing chart of each signal between a-a′ illustrated in FIGS. 5A and 5B is illustrated in FIG. 6A. The timing chart of each signal between b-b′ illustrated therein is illustrated in FIG. 6B. The timing chart of each signal between c-c′ illustrated therein is illustrated in FIG. 6C.

In FIGS. 5A and 5B, when the bias voltage Vs starts to be supplied to the conversion element 201, the imaging apparatus 100 performs the exposure imaging preparation operation in the exposure imaging preparation period. The exposure imaging preparation operation refers to an operation in which an initialization operation K is performed at least twice in order to stabilize the offset variation of the FPD 104.

The initialization operation refers to an operation in which an initial bias is applied to the conversion element before its storage operation to initialize the conversion element. In FIGS. 5A and 5B, a pair of a storage operation W and an initialization operation K is repeated several times as the exposure imaging preparation operation.

As illustrated in FIG. 6A, in the storage operation W, while the bias voltage Vs is applied to the conversion element 201, a non-conductive voltage Vss is applied to the switch element 202 to bring the switch elements 202 of all pixels into a non-conductive state.

In initialization operation K, the reset switch resets the integral capacity and the signal wiring of the integrating amplifier 203, and the drive circuit 102 supplies the conduction voltage Vcom to the drive wiring G1 to bring the switch elements T11 to T17 of pixels in the first row into a conductive state. The conversion element is initialized by the conductive state of the switch element.

At this point, the switch element outputs the electric charge of the conversion element as an electric signal. However, data corresponding to the electric signal is not output from the read circuit 103 because the sample and hold circuit and subsequent circuits are not operated during initialization operation in the present exemplary embodiment.

Thereafter, the integral capacity and the signal wiring are reset again to process the output electric signal. If the data is desired to be used as information about the offset variation characteristic, the sample and hold circuit and subsequent circuits are operated in the similar manner as in the exposure image output operation and the correction image output operation. Thus, the control of the conduction state of the switch elements and the reset are repeated in the second and third row to perform the initialization operation.

In the initialization operation, the reset switch may be maintained conductive also at least during the conduction state of the switch element to continue resetting. The conduction time period of the switch element in the initialization operation may be shorter than the conduction time period of the switch element in the exposure image output operation described below. In the initialization operation, the switch elements in a plurality of rows can be made conductive at the same time.

In such these cases, time consumed for the entire initialization operation can be reduced to allow quickly stabilizing variation in the characteristic of the detector. In the present exemplary embodiment, although the initialization operation K is shorter in period than the image output operation X in the exposure imaging operation period performed after the exposure imaging preparation operation, the initialization operation K may be substantially equal in period to the image output operation X.

The exposure imaging preparation operation is repeated until the control computer 108 receives the exposure request signal from the console 111. When the control computer 108 receives the exposure request signal, the control computer 108 controls the imaging apparatus 100 so as to stop the exposure imaging preparation operation and switch the exposure imaging preparation operation into the exposure imaging operation. Switching into the exposure imaging operation is carried out after a pair of the storage operation W and the initialization operation K being performed as the exposure imaging preparation operation is entirely completed.

For example, when the exposure request signal is received while the switch element in the second row is in a conductive state in the initialization operation K, the initialization operation is continued without stopping until the switch element in the final seven row is brought into a conductive state to complete the initialization operation K, and then the exposure imaging preparation operation is switched into the exposure imaging operation. If the exposure request signal is received during the storage operation W, the storage operation W may be immediately shifted to the initialization operation K.

In the exposure imaging operation, the imaging apparatus 100 performs the storage operation W′ in which the conversion element 201 generates electric charges according to an amount of the radiation with which the imaging apparatus 100 is irradiated, and the image output operation X in which the image data is output based on the electric charges generated in the storage operation W′. The storage operation W′ is substantially similar to the storage operation W in the exposure imaging preparation period, and is performed according to the period for which the imaging apparatus 100 is irradiated with the radiation.

As illustrated in FIG. 6B, in the image output operation X, the integral capacity and the signal wiring are reset, and the drive circuit 102 supplies the conduction voltage Vcom to the drive wiring G1 to bring the switch elements T11 to T17 in the first row into a conductive state. This operation outputs electric signals based on the electric charges generated by the conversion elements S11 to S17 in the first row to each signal wiring.

The electric signals output in parallel via the signal wirings are amplified by the operational amplifiers 203 and the variable amplifiers 204 in the amplification circuits 207. The sample and hold circuits 205 are operated by the control signal SH and store the amplified electric signals in parallel therein in the amplification circuits 207.

After the electric signals are stored, the integral capacity and the signal wiring are reset. After the reset, the conduction voltage Vcom is applied to the drive wiring G2 in a second row in the similar manner as in the first row to bring the switch elements T21 to T27 into a conductive state. In the period during which the switch elements T21 to T27 are brought into a conductive state, the multiplexer 208 sequentially outputs the electric signals stored in the sample and hold circuits 205.

Thereby, the electric signals read in parallel from the pixels in the first row are converted into a series image signal and output, and the A/D converter 210 converts the series image signal into image data for one row and outputs the image data. The above operation performed on a row basis from the first row to the second row causes the imaging apparatus 100 to output the image data for one frame.

As illustrated in FIGS. 5A and 5B, in the present exemplary embodiment, the correction imaging operation illustrated in FIG. 6C is performed to correct the dark current of the detection unit 101 and a fixed pattern noise at the time of transportation. Before the correction imaging operation, the imaging apparatus 100 performs the correction imaging preparation operation in which a pair of the storage operation W and the initialization operation K substantially similar to the exposure imaging preparation operation is executed a prescribed number of times obtained by determination results. The period for which the imaging apparatus 100 performs the above operation is referred to as “correction imaging preparation period.”

The number of times of repetition of a pair of the storage operation W and the initialization operation K is defined according to the length of the exposure imaging preparation period. When the control computer 108 provides the imaging apparatus 100 with the exposure request signal in the exposure imaging preparation period, the imaging apparatus 100 stops the exposure imaging preparation operation, as described above, and is shifted to the exposure imaging operation period. In other words, the length of the exposure imaging preparation period is determined by the length from the application of voltage to the imaging apparatus 100 to the control computer 108 receiving the exposure request signal from the console 111.

At this point, the imaging condition memory 109 stores the length of the exposure imaging preparation period. The control computer 108 provides the control unit 106 with a signal for controlling the initialization operation or the number of times of repetition of a pair of the storage operation and the initialization operation according to the length of the exposure imaging preparation period stored in the imaging condition memory 109. The control unit 106 provides the drive circuit 102 and the read circuit 103 with each control signal to cause the FPD 104 to perform the prescribed offset initialization operation.

After the exposure imaging preparation period, the imaging apparatus 100 performs the correction imaging operation. As illustrated in FIG. 6C, in the correction imaging operation period, there are performed the storage operation W′ in which the conversion element 201 generates electric charges in the dark state where the imaging apparatus 100 is not irradiated with the radiation and a correction image output operation F in which dark image data are output based on the electric charges generated in the storage operation W′. In the correction image output operation F, the imaging apparatus 100 performs an operation similar to the image output operation X.

The correction imaging preparation operation is described in detail below with reference to FIGS. 5A and 5B. FIG. 5A illustrates the operation of the imaging apparatus 100 in a case where the exposure imaging preparation period is short. If the exposure imaging preparation period is shorter than a predetermined time Tth, a pair of the storage operation W and the initialization operation K which are performed in the exposure imaging preparation period is performed only once.

As illustrated in FIG. 4A, the amount of variation in offset of the FPD 104 is large if the exposure imaging preparation period is shorter than the predetermined time Tth. For this reason, the correction imaging operation is desirably performed immediately after the exposure imaging operation so that the influence of a variation in offset can be eliminated.

Performing a pair of the storage operation W and the initialization operation K more than once as the correction imaging preparation operation increases a time period from the exposure imaging operation to the correction imaging operation. This may acquire a correction image whose amount of offset varies. In other words, a suitable correction image cannot be acquired for the exposure image, which may increase an image artifact.

On that account, a pair of the storage operation W and the initialization operation K is performed only once, thereby, the influence of a variation in offset can be reduced to allow acquiring the correction image suitably reflecting the offset at the time of the exposure imaging operation. However, a pair of the storage operation W and the initialization operation K needs to be performed at least once so that the storage time of the image output operation X in each row is made identical to that of the correction image output operation F in each row.

FIG. 5B illustrates the operation of the imaging apparatus 100 in a case where the exposure imaging preparation period is long. If the exposure imaging preparation period is longer than the predetermined time Tth, a pair of the storage operation W and the initialization operation K which are performed in the exposure imaging period is performed more than once or four times in the present exemplary embodiment.

As illustrated in FIG. 4A, the amount of variation in offset of the FPD 104 is small and stable if the exposure imaging period is longer than the predetermined time Tth. For this reason, an interval between the exposure imaging operation and the correction imaging operation may be increased. Since the amount of offset itself is decreased, the influence of an image lag caused by the irradiation with radiation becomes dominant after the exposure imaging operation.

The imaging apparatus 100 performs a pair of the storage operation W and the initialization operation K more than once as the correction imaging preparation operation to reduce the influence of the image lag caused by the irradiation with radiation. This quickly stabilizes a variation in offset in the FPD 104 after the irradiation with radiation to allow the correction imaging operation to be performed after the FPD 104 artificially returns to the offset state before the irradiation with radiation. The larger the number of times of repetition of a pair of the storage operation W and the initialization operation K is, the greater the effect is.

As illustrated in FIG. 4A, the longer the exposure imaging preparation period is, the more stable a variation in offset after the application of the bias voltage Vs is. Therefore, the number of times of repetition of a pair of the storage operation W and the initialization operation K can be increased to two or more. The number of times of repetition of a pair of the storage operation W and the initialization operation K is defined according to the length of the exposure imaging preparation period.

The larger the radiation dose is, the greater the influence of the image lag caused by the irradiation with radiation becomes. The number of times of repetition of a pair of the storage operation W and the initialization operation K may be defined according to the dose of radiation with which the imaging apparatus 100 is irradiated as well as the length of the exposure imaging preparation period.

As describe above, the number of times of repetition of a pair of the storage operation W and the initialization operation K is determined according to the length of the exposure imaging preparation period, and the imaging apparatus 100 executes the operations, thereby allowing the correction imaging with the influence of variation in offset reduced. More specifically, the correction imaging corresponding to the offset variation characteristic after the application of power to the FPD 104 is performed to enable a suitable offset correction.

This allows acquiring a radiation image fewer in image artifact independent of the length of the exposure imaging preparation period. In the present exemplary embodiment, the PIN photodiode is used as a photoelectric conversion element, however, a metal-insulator-semiconductor type (MIS-type) photo sensor may be used.

The block and circuit diagrams of an imaging apparatus according to a second exemplary embodiment of the present invention are similar to those in the first exemplary embodiment illustrated in FIGS. 1 and 2, so that the detailed description thereof is omitted herein.

In the present exemplary embodiment, when the correction imaging preparation operation is determined, the subsequent control of the imaging apparatus is switched according to the operation performed when the console 111 provides the exposure request signal in the exposure imaging preparation period as well as the length of the exposure imaging preparation period.

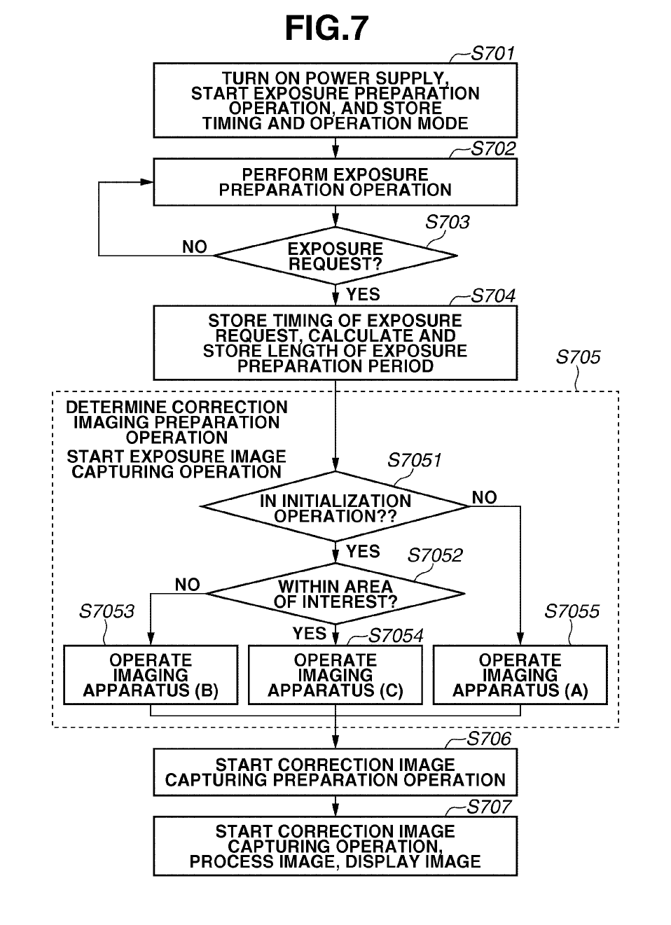

More specifically, the operation of the imaging apparatus is switched between the exposure imaging preparation period and the correction imaging preparation period. The operation of the imaging apparatus and the entire imaging system of the present exemplary embodiment is described below with reference to FIGS. 7 to 10C using a still-image mode as an example in a case where the exposure imaging preparation period is shorter than the predetermined time Tth.

As is the case with the first exemplary embodiment, in step S701, power is supplied to the FPD 104 by the operator operating the console 111 to start applying the bias voltage Vs to the conversion element, and the imaging apparatus 100 performs the exposure imaging preparation operation in step S702.

The imaging apparatus 100 performs the exposure imaging preparation operation until the console 111 outputs the exposure request signal in step S703. If the control computer 108 detects that the console 111 outputs the exposure request signal in step S703, the control computer 108 records the timing at which the exposure request signal is output, and calculates the length of the exposure imaging preparation period in step S704.

In the present exemplary embodiment, the exposure imaging preparation period is shorter than the predetermined time Tth, so that the control computer 108 selects to perform a pair of the storage operation W and the initialization operation K once. In step S7051 of step S705, the control computer 108 inquires of the control unit 106 whether the imaging apparatus 100 is in the initialization operation K when the exposure request signal is output.

In a case where the control computer 108 receives a signal “NO,” in other words, the signal that the imaging apparatus 100 is in the storage operation W, the control computer 108 instructs the control unit 106 to cause the imaging apparatus 100 to perform an imaging apparatus operation A described below in step S7055.

In a case where the control computer 108 receives a signal “YES,” in other words, the signal indicating that the imaging apparatus 100 is in the initialization operation K, the control computer 108 inquires of the control unit 106 whether the initialization operation is performed inside an area of interest at the moment the exposure request signal is output in step S7052. The area of interest is defined by the operator as an important area in a captured image plane in radiation capturing.

In a case where the control computer 108 receives a signal “NO,” in other words, the signal indicating that the initialization operation is performed outside the area of interest, the control computer 108 instructs the control unit 106 to cause the imaging apparatus 100 to perform an imaging apparatus operation B described below in step S7053.

In a case where the control computer 108 receives a signal “YES,” in other words, the signal indicating that the initialization operation is performed in the area of interest, the control computer 108 instructs the control unit 106 to cause the imaging apparatus 100 to perform an imaging apparatus operation C described below in step S7054. For example, in a radiation imaging apparatus having pixels of 2800 rows by 2800 columns, the operator defines a central portion from the 800th to 2000th rows as the area of interest.

In a case where the imaging apparatus 100 is performing the storage operation W at the moment the exposure request signal is output, the imaging apparatus 100 performs the imaging apparatus operation A in step S7055. In a case where the imaging apparatus 100 is performing the initialization operation Kin the 500th row at the moment the exposure request signal is output, the imaging apparatus 100 performs the imaging apparatus operation B in step S7053.

In a case where the imaging apparatus 100 is performing the initialization operation K in the 1500th row at the moment the exposure request signal is output, the imaging apparatus 100 performs the imaging apparatus operation C in step S7054.

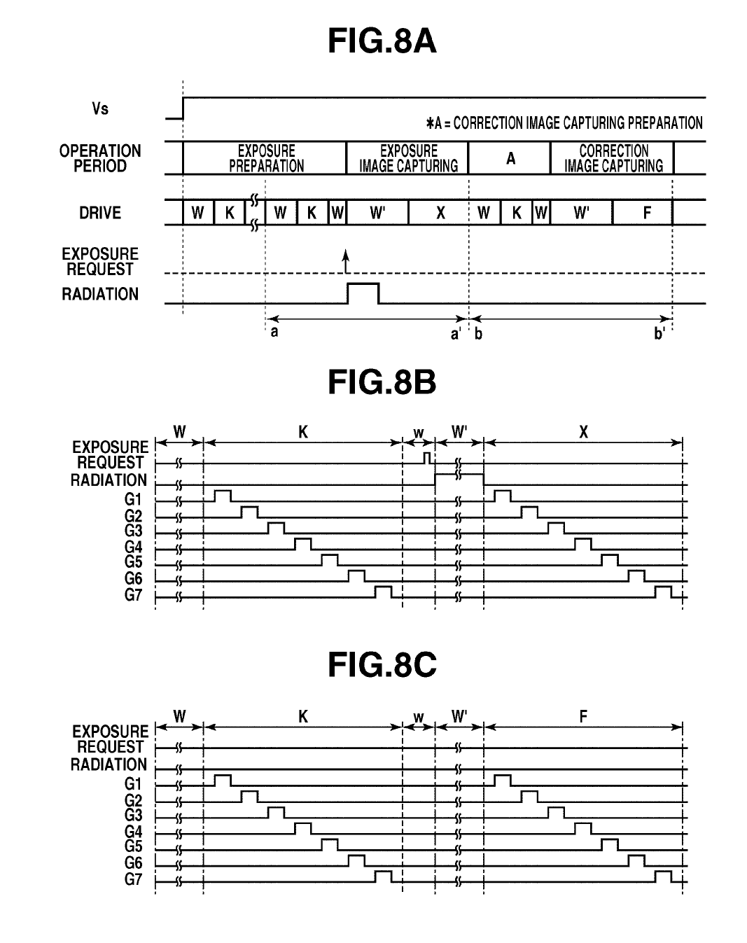

The imaging apparatus operation A is described below with reference to FIGS. 8A to 8C. If the exposure request signal is output while the imaging apparatus 100 is performing the storage operation W, the imaging apparatus 100 interrupts the storage operation W and immediately shifts to the exposure imaging operation.

In the exposure imaging operation after the interrupted storage operation w, as is the case with the first exemplary embodiment, the imaging apparatus 100 performs the storage operation W′ in which the conversion element 201 generates electric charges according to the radiation with which the imaging apparatus 100 is irradiated and the image output operation X in which the image data are output based on the electric charges generated in the storage operation W′.

A timing chart between a-a′ illustrated in FIG. 8A is illustrated in FIG. 8B. A timing chart between b-b′ illustrated therein is illustrated in FIG. 8C. FIGS. 8B and 8C illustrate only the timing of the conduction voltage Vcom which the drive circuit 102 applies to the drive wirings G1 to G7.

Interrupting the storage operation W immediately after the output of the exposure request signal enables an exposure delay to be reduced. The exposure delay refers to the time required from the output of the exposure request signal by the operator to the actual irradiation with radiation by the radiation generating apparatus 110. It is desirable to reduce the exposure delay because the exposure delay becomes a great factor in which the operator loses timing to be desired to capture an image due to fluctuation and movement of an object.

Following the exposure imaging operation, the imaging apparatus 100 performs a pair of the storage operation W and the initialization operation K once as the exposure imaging preparation operation. The imaging apparatus 100 further performs the interrupted storage operation w after a pair of the storage operation W and the initialization operation K as the exposure imaging preparation operation.

After that, as is the case with the first exemplary embodiment, the imaging apparatus 100 performs the storage operation W′ in which the conversion element 201 generates electric charges in the dark state where the imaging apparatus 100 is not irradiated with the radiation, and the correction image output operation F in which dark image data is output based on the electric charges generated in the storage operation W′ as the correction imaging operation.

Performing the storage operation w substantially the same in length as the storage operation interrupted in the correction imaging preparation period before the correction imaging operation allows substantially equalizing the time of the storage operation for performing the image output operation X with that of the storage operation for performing the correction image output operation F. This allows an optimum correction imaging for the offset correction.

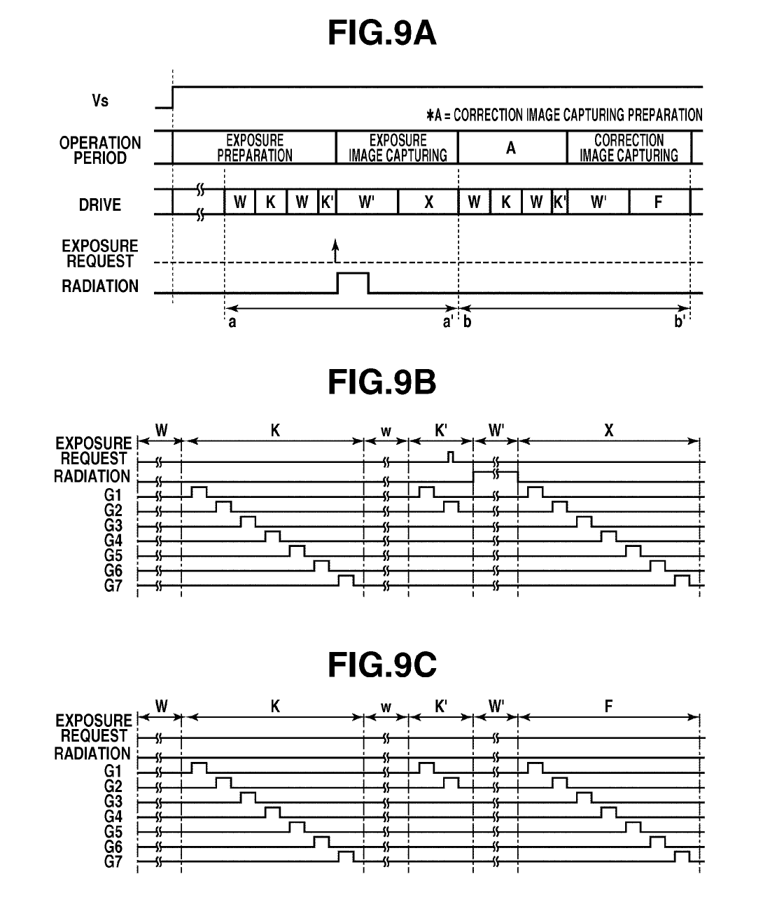

The imaging apparatus operation B is described below with reference to FIGS. 9A to 9C. The imaging apparatus operation B refers to the operation of the imaging apparatus 100 in a case where the imaging apparatus 100 is scanning outside the area of interest defined by the operator in the initialization operation K at the moment the exposure request signal is output.

In this case, the imaging apparatus 100 interrupts the initialization operation K at the moment the exposure request signal is output, and immediately shifts to the exposure imaging operation. More specifically, after the initialization operation K′, the radiation generating apparatus 110 irradiates an object with radiation, and the imaging apparatus 100 performs the storage operation W′ and the image output operation X for outputting the image data.

A timing chart between a-a′ illustrated in FIG. 9A is illustrated in FIG. 9B. A timing chart between b-b′ illustrated therein is illustrated in FIG. 9C. In FIGS. 9B and 9C, the third to fifth rows are defined as the area of interest. A case is exemplified in which the exposure request signal is output while the imaging apparatus 100 is performing the initialization operation in the second row.

Interrupting the initialization operation K immediately after the exposure request signal is output allows the exposure delay to be reduced. Following the exposure imaging operation, the imaging apparatus 100 performs a pair of the storage operation W and the initialization operation K once as the offset initialization operation, and then performs a pair of the storage operation W and the interrupted initialization operation K′ once.

After that, the imaging apparatus 100 performs the correction imaging operation. The above operation enables acquiring the correction image adequately reflecting the offset state at the time of capturing an exposure image.

Interrupting the initialization operation K in midstream may cause an image step on the exposure image. Performing the interrupted initialization operation K′ before the correction imaging causes the image unevenness similar to that on the exposure image also on the correction image, so that the image step can be corrected by the offset correction.

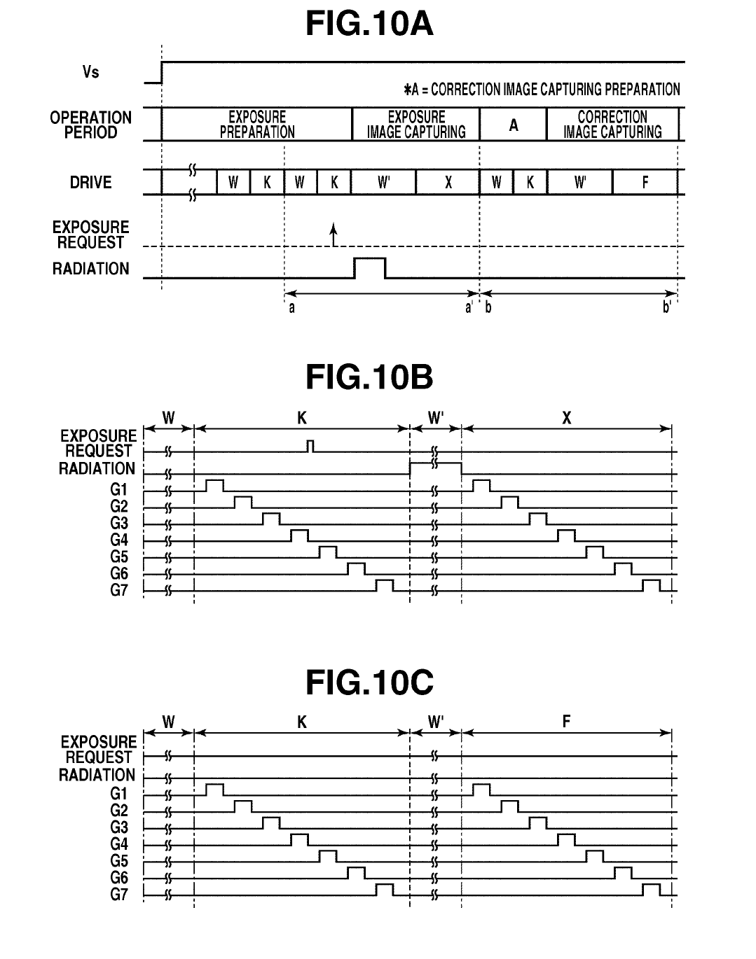

The imaging apparatus operation C is described below with reference to FIGS. 10A to 10C. The imaging apparatus operation C refers to the operation of the imaging apparatus 100 in a case where the imaging apparatus 100 is scanning inside the area of interest defined by the operator in the initialization operation K at the moment the exposure request signal is output. In this case, the imaging apparatus 100 continues the initialization operation even if the exposure request signal is output, and performs the initialization operation in all of the rows. The imaging apparatus 100 performs the exposure imaging operation after the initialization operation is completed in all of the rows.

A timing chart between a-a′ illustrated in FIG. 10A is illustrated in FIG. 10B. A timing chart between b-b′ illustrated therein is illustrated in FIG. 10C. In FIGS. 10B and 10C, the third to fifth rows are defined as the area of interest. A case is exemplified in which the exposure request signal is output while the imaging apparatus 100 is performing the initialization operation in the fourth row.

The imaging apparatus operation C is different from the imaging apparatus operation B in that the initialization operation is performed in all of the rows without the initialization operation being interrupted. If the initialization operation is interrupted inside the area of interest and the image unevenness on the exposure image is not corrected by the imaging method in the imaging apparatus operation B, the image quality is significantly degraded.

Then, the imaging method is executed in which it is determined whether the initialization operation is being performed inside the area of interest at the moment the exposure request signal is output and, if the initialization operation is being performed inside the area of interest, the initialization operation is continued. In other words, if the initialization operation is being performed inside the area of interest, the operation is executed which hardly causes the image unevenness.

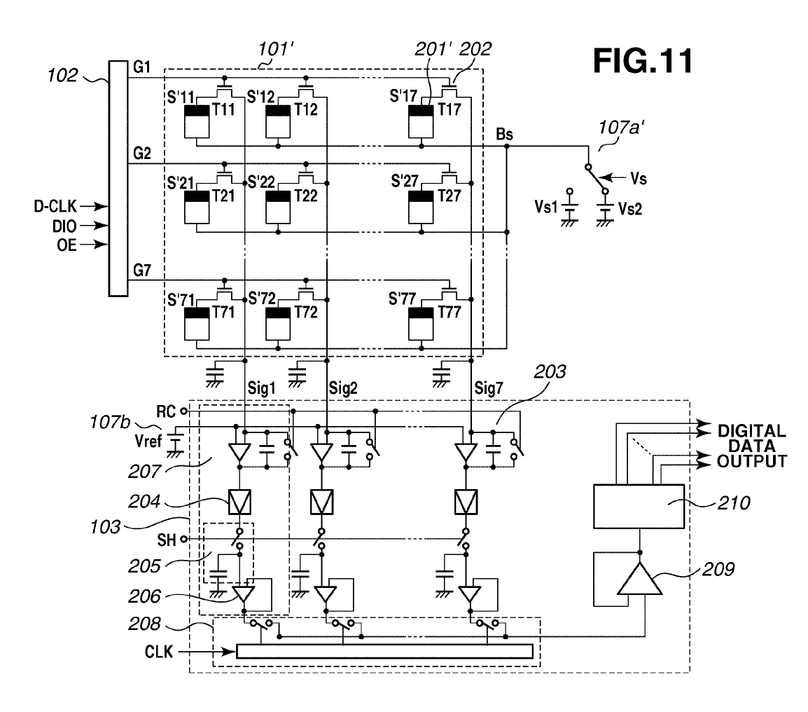

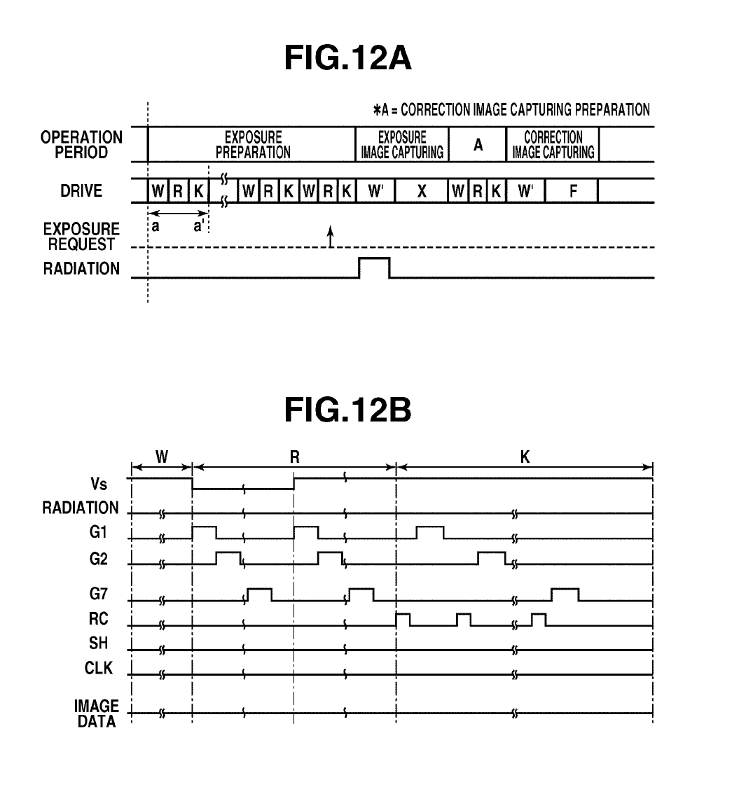

In the present exemplary embodiment, the PIN photodiode is used as a photoelectric conversion element, however, a MIS photo sensor may be used. The operation of the imaging apparatus 100 using the MIS photo sensor in the present exemplary embodiment is described below with reference to FIG. 11 and FIGS. 12A and 12B.

A detection unit 101′ illustrated in FIG. 11 uses the MIS photo sensor as the conversion element. In a case where the MIS photo sensor is used, the imaging apparatus 100 repeats a pair of the storage operation W, a refresh operation R, and the initialization operation K more than once as the exposure imaging preparation operation.

The storage operation W and the initialization operation K are similar to those described in the first exemplary embodiment. The refresh operation R is performed to delete either one of positive or negative electric charges generated in the conversion element 601 and remaining in the conversion element 201′.

In the operation of the imaging apparatus 100, the bias voltage Vs1 is applied to the bias wiring Bs in the operations except the refresh operation R. This corresponds to the bias voltage Vs in the first exemplary embodiment.

At the time of the refresh operation R, the bias voltage Vs2 is applied to the bias wiring Bs. The bias voltage Vs2 is set so that |Vs1−Vref|>|Vs2−Vref1|.

This applies the bias |Vs2−Vref| to the conversion element 201′ to delete either one of the electric charges remaining in the conversion element. This is sequentially performed on a row basis to refresh the conversion elements of all pixels. The bias voltage is returned to the bias voltage Vs1 and the similar operation is performed, then completing the refresh operation R.

If the exposure request signal is output in the midstream of the storage operation W and the initialization operation K, the imaging apparatus 100 operates in the manner similar to the imaging apparatus using the PIN photodiode in the present exemplary embodiment. However, the imaging apparatus 100 performs a set of the storage operation W, the refresh operation R, and the initialization operation K once as the correction imaging preparation operation.

If the exposure request signal is output in the midstream of the refresh operation R, the imaging apparatus 100 continues the refresh operation until the refresh operation in all of rows is completed, and then performs the initialization operation K.

After the initialization operation K is completed, the imaging apparatus 100 performs the exposure imaging operation. The imaging apparatus 100 performs a set of the storage operation W, the refresh operation R, and the initialization operation K once as the correction imaging preparation operation as described above. Thereafter, the imaging apparatus 100 performs the correction imaging operation.

In the present exemplary embodiment, a case is exemplified in which the exposure imaging preparation period is short. However, in a case where the exposure imaging preparation period is long, as described in the first exemplary embodiment, the offset initialization operation is performed more than once.

As described above, the subsequent imaging method is switched according to the operation mode of the imaging apparatus 100 at the point when the exposure request signal is provided from the console 111, thereby enabling the exposure delay to be reduced.

In the present exemplary embodiment, the offset correction is enabled corresponding to variation in offset after power is applied to the FPD 104 and, furthermore, reduction in the exposure delay and a satisfactory offset correction corresponding thereto can be realized.

The present invention can also be realized by executing the following processing. The processing is performed in such a manner that software (program) for realizing the functions of the above exemplary embodiments is supplied to the system or the apparatus via a network or various storage media, and the computer (or a CPU or an MPU) of the system or the apparatus is caused to read and execute the program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-216924 filed Sep. 28, 2010, which is hereby incorporated by reference herein in its entirety.

What is claimed is:

1. An imaging apparatus comprising:
a detector in which a plurality of pixels each including a conversion element configured to convert radiation or light into an electric charge is arranged in a matrix form, wherein the detector performs an exposure imaging operation for outputting exposure image data corresponding to radiation or light with which the detector is irradiated, a correction imaging operation for outputting correction image data that is image data in a dark state for correcting the exposure image data, an exposure preparation operation for stabilizing a characteristic of the conversion element during a time between the start of application of a bias to the conversion element and the exposure imaging operation, and a correction imaging preparation operation including an initialization operation for initializing the conversion element between the exposure imaging operation and the correction imaging operation;
a correction unit configured to correct the exposure image data using the correction image data; and
a control unit configured to control the operation of the detector,
wherein the control unit determines the number of times of the initialization operation according to the amount of variation in offset at the time of shifting from the exposure preparation operation to the exposure imaging operation, and controls the operation of the detector so as to perform the initialization operation based on the determined number of times.

2. The imaging apparatus according to claim 1, wherein the control unit determines whether the amount of variation in offset is greater than a predetermined threshold, and determines the number of times of the initialization operation based on the results of the determination.

3. The imaging apparatus according to claim 2, wherein, in a case where the control unit determines that the amount of variation in offset is greater than the predetermined threshold, the control unit determines the number of times of the initialization operation as one, and controls the operation of the detector so as to perform the initialization operation once and, in a case where the control unit determines that the amount of variation in offset is equal to or smaller than the predetermined threshold, the control unit determines the number of times of the initialization operation as two or more, and controls the operation of the detector so as to perform the initialization operation twice or more.

4. The imaging apparatus according to claim 3, wherein the control unit includes a memory storing information for determination including the predetermined threshold and information for determining the operation of the detector, and
wherein the control unit determines whether the amount of variation in offset is greater than the predetermined threshold using the information for determination, and determines the number of times of the initialization operation using the results of the determination and the information for determining the operations.

5. The imaging apparatus according to claim 4, wherein the information for determination further includes an offset variation characteristic which is a characteristic between the time elapsing from the start of application of the bias to the conversion element and the amount of variation in offset, and the control unit measures the length of period of the exposure imaging preparation operation and determines whether the amount of variation in offset is greater than the predetermined threshold based on the information for determination and the length of the period.

6. The imaging apparatus according to claim 4, wherein the control unit acquires the amount of variation in offset from the difference between two offset image data continuously acquired in the exposure imaging preparation operation and compares the acquired amount of variation in offset with the predetermined threshold to determine whether the amount of variation in offset is greater than the predetermined threshold.

7. The imaging apparatus according to claim 4, wherein the information for determining the operations is a look-up table previously defining the number of times of the initialization operation corresponding to the results of comparison of the amount of variation in the offset with the predetermined threshold.

8. The imaging apparatus according to claim 1,
wherein each pixel further includes a switch element configured to output an electric signal corresponding to the electric charge,
wherein the detector includes a detection unit in which the plurality of pixels is arranged, a drive circuit configured to control the conduction state of the switch element to drive the detection unit, and a read circuit configured to output the electric signal output from the detection unit via a signal wiring connected to the switch element as image data,
wherein the read circuit includes a reset switch configured to reset the signal wiring, and
wherein the control unit controls the drive circuit and the reset switch to cause the detector to perform the initialization operation.

9. The imaging apparatus according to claim 1,
wherein the exposure preparation operation and the correction imaging preparation operation include a storage operation in the dark state where the conversion element is not irradiated with radiation or light and the initialization operation, and
wherein the control unit controls the operation of the detector so that the detector interrupts the storage operation if the operation at the time of an exposure request signal being provided during the exposure imaging preparation operation is the storage operation, shifts to the exposure imaging operation, and performs the storage operation substantially the same in length as the storage operation interrupted between the initialization operation in the correction imaging preparation operation and the correction imaging operation.

10. The imaging apparatus according to claim 9,
wherein, when an area of interest is set on the detector, the control unit controls the operation of the detector so that the detector interrupts the initialization operation if the operation at the time of the exposure request signal being provided during the exposure preparation operation is the initialization operation outside the area of interest, shifts to the exposure imaging operation, and performs the storage operation and the interrupted initialization operation between the initialization operation in the correction imaging preparation operation and the correction imaging operation.

11. The imaging apparatus according to claim 8, further comprising a power supply unit including a reference power supply configured to supply a reference voltage to one electrode of the conversion element via the switch element, and a bias power supply configured to supply a bias voltage to the other electrode of the conversion element,
wherein the conversion element is a MIS-type photo sensor,
wherein the power supply unit is configured to supply a bias which is different from one in the storage operation to the MIS-type photo sensor in a refresh operation for deleting either one of positive and negative electric charges remaining in the MIS-type photo sensor,
wherein the exposure imaging preparation operation and the correction imaging preparation operation include the storage operation, the refresh operation, and the initialization operation in this order, and
wherein the control unit controls the operation of the detector so that the detector shifts to the exposure imaging operation after the completion of the refresh operation and the initialization operation if the operation at the time of the exposure request signal being provided during the exposure imaging preparation operation is the refresh operation.

12. An imaging system comprising:
the imaging apparatus according to claim 1; and
a radiation generating apparatus configured to irradiate the imaging apparatus with the radiation.

13. A method for controlling an imaging apparatus including a detector in which a plurality of pixels each including a conversion element configured to convert radiation or light into an electric charge is arranged in a matrix form and which performs an exposure imaging operation for outputting exposure image data corresponding to radiation or light with which the detector is irradiated, and a correction imaging operation for outputting correction image data, which is image data in a dark state for correcting the exposure image data, the imaging apparatus controlling the operation of the detector so that the exposure image data is corrected using the correction image data and output, the method comprising:
performing an exposure imaging preparation operation for stabilizing the characteristic of the conversion element during the time between the start of application of a bias to the conversion element and the exposure imaging operation, and
performing a correction imaging preparation operation including an initialization operation for initializing the conversion element between the exposure imaging operation and the correction imaging operation based on the number of times determined in correspondence to the amount of variation in offset of the conversion element at the time of transferring from the exposure imaging preparation operation to the exposure imaging operation.
